(19) United States
(12) Patent Application Publication
(10) Pub. No.: US 2004/0223567 A1
(43) Pub. Date: Nov. 11, 2004

(54) CLOCK RECOVERY SYSTEM

(76) Inventor: Ming-Kang Liu, San Jose, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/249,826

(22) Filed: May 9, 2003

(51) Int. Cl. H04L 7/00

(52) U.S. Cl. 375/355

(57) ABSTRACT

A system for generating a phase detection signal, for recovering a transmitter clock, and for sampling data in a received signal. A stream of digital samples is collected from the received signal at a sampling phase and autocorrelation based on the digital samples is used to derive the phase detection signal. The phase detection signal is then further usable to recover the transmitter clock by generating a reference signal and locking it with the received signal. The recovered transmitter clock is yet further usable to sample data in the received signal. Optionally, another autocorrelation based on the digital samples may be used to also derive a phase for optimally sampling data in a received signal.

### BACKGROUND OF INVENTION

1. Technical Field

The present invention relates generally to electronic digital communications, and more particularly to band limited digital communication systems where clock recovery is required in the presence of strong intersymbol interference.

2. Background Art

Working with a remotely received digital communications signal can pose the fundamental problems of clock recovery and optimum phase selection. Clock recovery is the process of synchronizing a receiver clock with the transmitter clock used when the signal was generated. Phase selection is the process of selecting a phase with respect to the receiver clock at which to sample the received signal. Such a selection is “optimum” when it provides the best signal-to-noise ratio (SNR) for accurate data recovery from the received signal.

As a signal is transmitted, the media through which it passes may also be band limited (sometimes termed a “dispersive channel”), and this can severely distort the signal from its original transmitted form. Signal echo can be another factor, as can crosstalk, noise, and still other factors at the various stages of communication.

A number of factors can exacerbate solving either or both of these fundamental problems. For instance, when a signal is transmitted, the transmitter clock used to generate it may drift or be unstable. This “clock jitter” makes both of the problems reoccurring ones that must be solved and resolved on an ongoing basis. The signal can also be severely distorted from its original form as it is transmitted. For instance, signal echo, crosstalk, noise, and still other factors can occur at the various stages of communication.

One factor is of particular present interest here. As a signal is transmitted, the media through which it passes may be band limited, and this can severely distort the signal from its original transmitted form. Intersymbol interference (ISI), as this result of band-limited transmission is termed, is a representation of the distortion of the symbol of interest in terms of neighboring symbols. Beyond a certain threshold, ISI compromises the integrity of the data communicated in the signal.

FIG. 1a-b (background art) are graphs depicting a single digital pulse before and after being effected by ISI. FIG. 1a stylistically shows the original transmitted pulse 10, and how it has a clear center point 12, leading edge 14, and trailing edge 16. FIG. 1b stylistically shows the received pulse 20, and how in it a corresponding center point 22, leading edge 24, and trailing edge 26 are not clearly defined. The before and after pulses 10, 20 differ considerably because of the band limited nature of the channel impulse response. In the received pulse 20, the leading edge 24 defines a precursor ISI region 28, where some of the energy of the original transmitted pulse 10 has been transferred. In transmission, this portion of the pulse will affect neighboring symbols transmitted earlier. Similarly, in concept, the trailing edge 26 in the received pulse 20 defines a postcursor ISI region 30 where a different portion of the energy of the transmitted pulse 10 has also been transferred. In transmission, this portion of the pulse will affect neighboring symbols transmitted later. The energy transfers into the ISI regions 28, 30 will typically differ, as is the case in the exemplary representation in FIG. 1b.

For band limited digital communication systems, the transmission is said to have strong ISI when the impulse response is nonzero over a large number of symbol intervals. FIG. 2a-b (background art) are graphs depicting a plurality of digital pulses as transmitted and received, respectively. The signals in these figures might represent, for instance, the binary data “11100100.” As can be observed, precursor and postcursor energy transfers can additively combine so that symbols in a signal interfere. When there is strong ISI, as is the case in FIG. 2b, the impulse response duration can extend over multiple symbol intervals and make clock recovery very difficult.

Numerous examples exist of the need to solve the fundamental problems in digital communications. In twisted-pair 1000 BASE-T or 100 BASE-T transmission (IEEE Standard 802.3), a 100 MHz signal typically suffers significant loss over a transmission of only 100 meters. This loss is equivalent to a low pass filtering, and results in a long impulse response tail, or strong ISI. Similarly, emerging gigabit Ethernet systems have strong echo, and as each pair is used for both transmitting and receiving data strong crosstalk occurs as four transmissions, over four pairs, takes place at the same time in the same cable. Yet another example is Symmetric High Speed Digital Subscriber Line (SHDSL), under the standard defined by ITU-T. Here, a 1 MHz signal is transmitted over one phone twisted-pair for a range of up to 6,000 meters and, similar to gigabit systems, typically suffers strong from ISI, echo, and crosstalk.

The problems of clock recovery and optimum phase sampling have long been recognized and considerable effort has been applied to them, but without adequately solving them, or solving them without raising equally or even more daunting problems instead.

Most clock recovery schemes today use a phase lock loop (PLL). In basic form, a phase lock loop consists of a phase detector that is used to drive a variable clock oscillator. The phase detector accepts a received signal and a reference signal, and produces a phase difference signal. The phase difference signal drives the variable clock oscillator, which produces the reference signal, which is accepted by the phase detector, etc., thus creating a servo loop. By virtue of this feedback arrangement, the reference signal is brought into phase and “locks” with the received signal. In practice, a loop filter (LF) is provided to tailor the phase difference signal to drive the variable clock oscillator, and the variable clock oscillator is usually a voltage controlled oscillator (VCO) or a current controlled oscillator (ICO).

FIG. 3 (background art) is a diagram depicting the elements and operating principle of a simple phase lock loop 40. A received signal 42 (Rₓ) is sampled by a phase detector 44 and compared with a reference signal 46 to produce a phase difference signal 48 (Î [symbol] ). The phase difference signal 48 is converted by a loop filter 50 into a driving signal 52 exhibiting the phase difference, now as a voltage (V). A voltage controlled oscillator (VCO 54) receives and is controlled with the driving signal 52, providing the reference signal 46 that is fed back into the phase detector 44. In the greater context of digital communications, once the phase lock loop 40 locks, the reference signal 46 may be used as a clock signal for sampling the received signal 42 and performing data recovery.

A simple phase lock loop circuit, such as the phase lock loop 40 in FIG. 3, may be adequate for clock recovery when a received signal has sufficient transitions and negligible ISI. The phase detector can then satisfactorily compare the transitions in the received signal with the reference signal output by the VCO or ICO. However, when the received signal suffers from strong ISI, for instance, this simple approach will fail because the received signal will lack clear, detectable transitions.

FIG. 4 (prior art) is a block diagram illustrating a more sophisticated approach that is commonly used for clock recovery in the presence of ISI. This approach, referred as the Mueller-Muller method, correlates a received signal with its detected output so that a correlation output is produced that is a monotonic function of the phase difference between the data transitions and the recovered clock. Unfortunately, among the various limitations of the Mueller-Muller method, a critical one is its need for a correctly detected output to begin with. This, in turn, requires proper equalization adaptation to reduce the ISI for correction detection. Since proper equalization adaptation depends on good clock recovery and good clock recovery depends on proper equalization adaptation, a “chicken-and-egg” type problem is presented.

Another limitation of the Mueller-Muller method is that it does not provide information related to the optimum phase sampling for maximizing signal detection performance (i.e., to our second fundamental problem). With reference again briefly to FIG. 1b, it can be seen that the center point 22 of the received pulse 20 is the optimum point at which to perform sampling. Unfortunately, in the presence of strong ISI, as can be seen in FIG. 2b, finding the best point, i.e., phase, at which to sample can be difficult.

To solve these limitations, what is needed is a technique that recovers a clock directly from a received signal. What is also needed is a technique that provides a criterion for optimizing the phase at which to sample the received signal is sampled, so that equalizers can be reliably trained and data can be correctly detected. Preferably, one technique is desired that fills both of these needs. Furthermore, such a technique should desirably Work well when a received signal has strong ISI and/or other factors changing it from its original form as generated and transmitted.

### SUMMARY OF INVENTION

Accordingly, it is an object of the present invention to provide a system for generating a phase detection signal suitable for recovering a transmitter clock and sampling data in a received signal.

Briefly, one preferred embodiment of the present invention is a system for generating a phase detection signal based on a received signal that has been generated based on a transmitter clock. A stream of digital samples of the received signal is collected at a sampling phase. A stream of correlated data is then calculated based on autocorrelation of the stream of digital samples. And the phase detection signal is then derived based on the stream of correlated data.

Briefly, another preferred embodiment of the present invention is a system for recovering a transmitter clock from a received signal. A phase detection signal is derived based on autocorrelation of the received signal. A reference signal is then generated based on the phase detection signal. And the received signal is locked with responsive to the reference signal, thus synchronizing the reference signal with the transmitter clock and thereby recovering the transmitter clock.

Briefly, yet another preferred embodiment of the present invention is a system for sampling data in a received signal that has been generated based on a transmitter clock. The transmitter clock is recovered based on autocorrelation of the received signal. A sampling phase is then selected. And the received signal is sampled for the data based on the transmitter clock and the sampling phase.

An advantage of the present invention is that it can provide a phase detection signal suitable for transmitter clock recovery and data sampling directly from a received signal, without having an already correctly detected clock recovery output to begin with.

Another advantage of the invention is that it can provide its phase detection signal when a received signal has been subject to clock jitter prior to transmission or has been degraded during transmission by factors such as echo, crosstalk, and noise. Furthermore, the invention is particularly able to provide its phase detection signal when the transmission has been band-limited and the received signal exhibits intersymbol interference (ISI).

And another advantage of the invention is that it works with and compliments systems for optimizing the phase at which to perform data sampling in a received signal.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF DRAWINGS

The purposes and advantages of the present invention-will be apparent from the following detailed description in conjunction with the appended figures of drawings in which:

FIG. 1a-b (background art) are graphs depicting a single digital pulse as it is effected by channel impulse response, wherein FIG. 1a shows the pulse as transmitted and FIG. 1b shows the pulse as received;

FIG. 2a-b (background art) are graphs depicting a plurality of digital pulses, as transmitted and as received, and illustrating energy transfer causing intersymbol interference (ISI);

FIG. 3 (prior art) is a diagram depicting the elements and operating principle of a simple phase lock loop used for clock recovery;

FIG. 4 (prior art) is a block diagram illustrating the Mueller-Muller method commonly used for clock recovery in the presence of ISI;

FIG. 5a-b are graphs related to a Special Function, R_{Î}_{³}[0]-R_{Î}_{³}[1], and its use for controlling clock recovery, wherein FIG. 5a depicts the Special Function itself and FIG. 5b depicts the difference of even and odd datastream based instances of the Special Function, in both cases with respect to a sampling phase Ï

[symbol]

FIG. 6a-b are graphs related to an example of the Special Function and its use for controlling phase sampling, wherein FIG. 6a shows an example case where a channel's impulse response is defined by a symmetric triangle function of width 2T_{S} with its center peak equal to 1 and FIG. 6b shows how the Special Function provides a maxima at the point for optimum phase sampling;

FIG. 7 is a schematic block diagram depicting a clock recovery circuit according to the present invention; and

FIG. 8 is a schematic block diagram depicting a phase-sampling circuit according to the present invention.

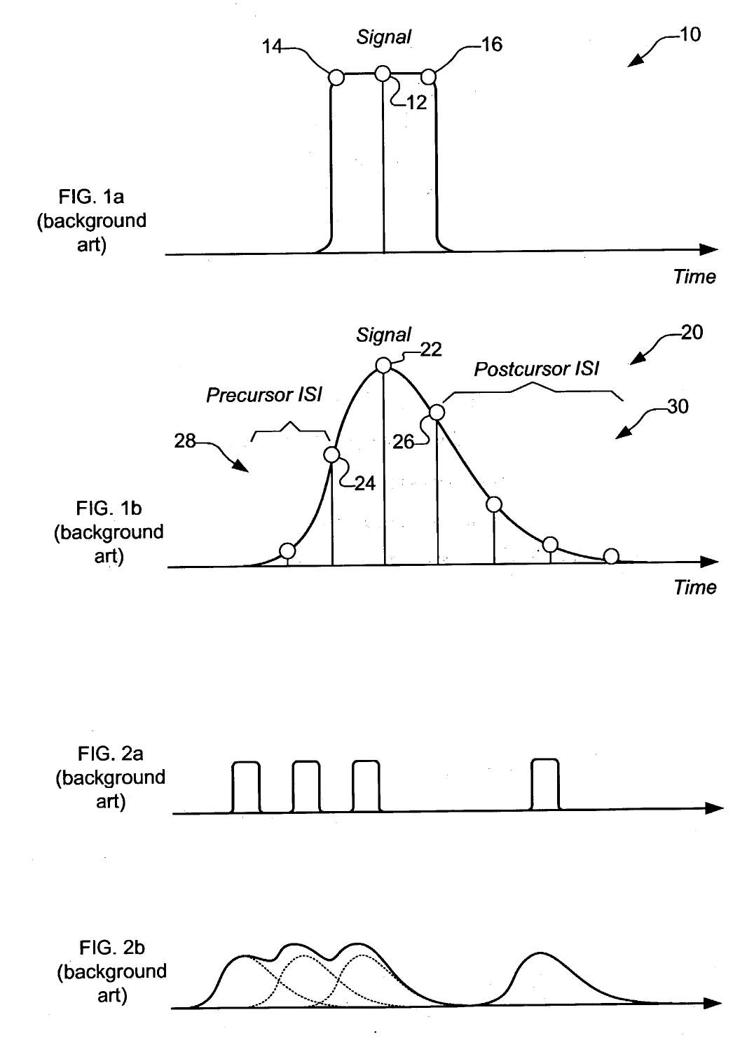

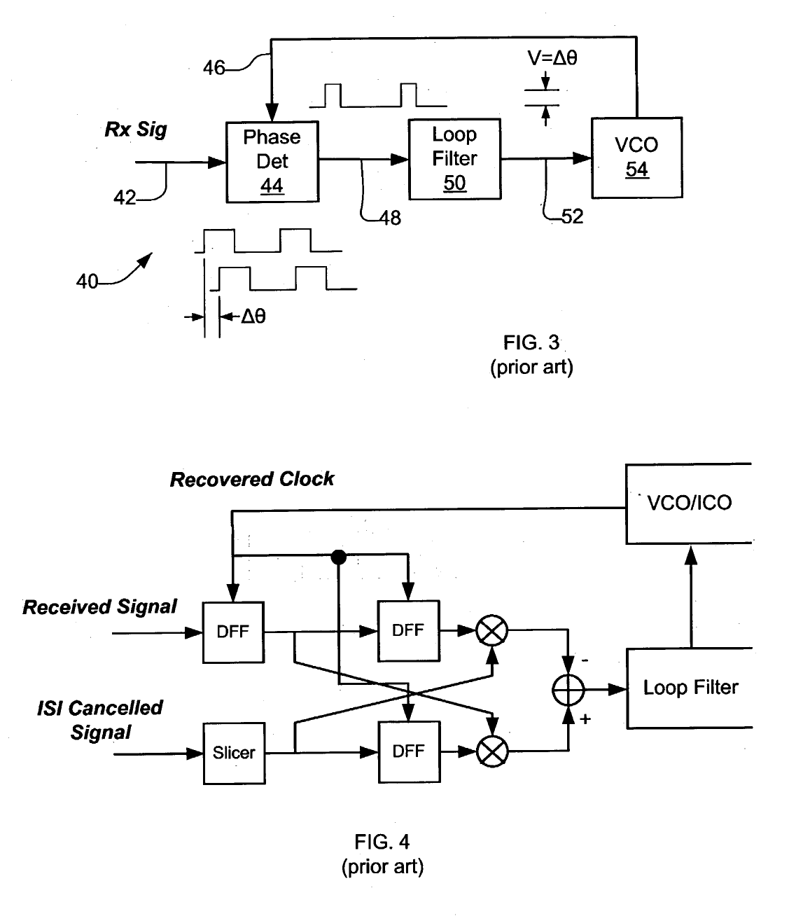

In the various figures of the drawings, like references are used to denote like or similar elements or steps.

### DETAILED DESCRIPTION

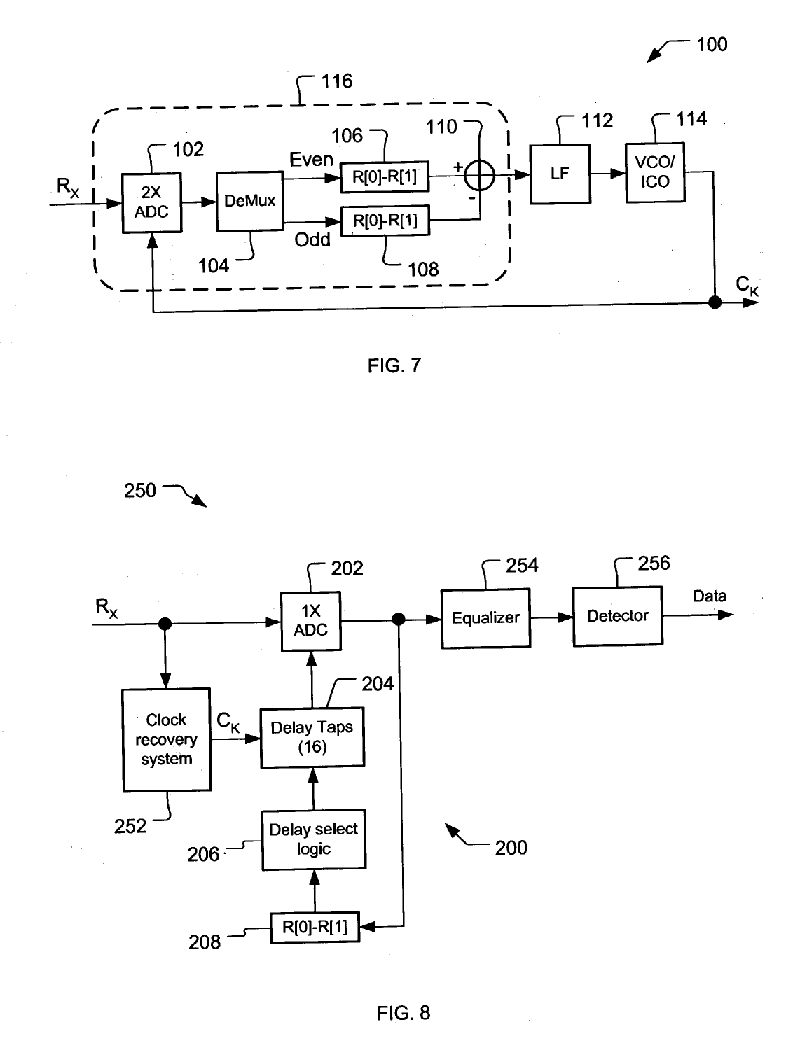

A preferred embodiment of the present invention is a clock recovery system. As illustrated in the various drawings herein, and particularly in the view of FIG. 7, a preferred embodiment of the invention is depicted by the general reference character 100.

Before turning to specific embodiments of the present invention, we first provide a discussion of operating principles and their derivation. Specifically, the following paragraphs describe modeling of the communications channel and intersymbol interference, some useful autocorrelation computations to derive a Special Function, and properties of that Special Function. We then turn to a discussion of using of the Special Function for both clock recovery and optimum phase sampling.

I. MODELING OF THE CHANNEL AND INTERSYMBOL INTERFERENCE (ISI)

In a baseband, band-limited digital communication system, a received signal can be expressed by:

$$\text{EQ. 1:} \\ r ( t ) = {\sum }_{k} {A}_{k} h ( t - {kT}_{s} )$$

The amplitude modulated output according to the transmitted data here is A_{k′} and h(t) is the impulse response of the channel. If the signal is sampled at the symbol rate, the sampled output can then be expressed by:

$$\text{EQ. 2:} \\ \begin{matrix}{r}_{n} = r ( {nT}_{S} + τ ) \\ = {\sum }_{k} {A}_{k} h ( {nT}_{S} - {kT}_{S} + τ ) = {\sum }_{k = 0} {A}_{n - k} h ( {kT}_{S} + τ ) \\ ≡ {\sum }_{k = 0} {A}_{n - k} {h}_{k} = {A}_{n - d} {h}_{d} + {\sum }_{0 \leq k < d} {A}_{n - k} {h}_{k} + {\sum }_{k > d} {A}_{n - k} {h}_{k}\end{matrix}$$

The first term on the right hand side of EQ. 2 is the desirable signal term, the second term is the precursor ISI due to symbols yet to arrive, and the third term is the postcursor ISI due to symbols that previously arrived. The variable Ï [symbol] here represents the sampling phase and a correct clock recovery is assumed. When the channel is ideal or there is no ISI, only h_{d} is nonzero.

II. Autocorrelation Computations

Autocorrelation for the above sampled stream can be performed. With a delay of m symbol intervals, the time averaged m-th autocorrelation function may be computed as:

$$\text{EQ. 3:} \\ {R}_{r} [ m ] = \frac{1}{N} {\sum }_{n = 0}^{N - 1} {r}_{n} {r}_{n + m}$$

If it is assumed that the sequence Aₖ is an independent and identical random process and that the computation interval is long enough, the autocorrelation function is approximately given by:

$$\text{EQ. 4:} \\ {R}_{r} [ m ] = {\sum }_{n = 0} {h}_{n} {h}_{n + m}$$

Specifically, this provides for R_{Î}_{³}[0]=h₀²+h₀²+ . . . and R_{Î}_{³}[1]=h₀h₁+h₁h₂+ . . . and from this can be formed the subtraction:

$$\text{EQ. 5:} \\ {R}_{r} [ 0 ] - {R}_{r} [ 1 ] = \frac{1}{2} {\sum }_{n = - ∞}^{∞} {( {h}_{n} - {h}_{n + 1} )}^{2}$$

EQ. 5 is termed the “Special Function” herein. It can be appreciated that in the particular case of an ideal channel, where there is no ISI or only h_{d} is nonzero, the Special Function simply becomes R_{Î}_{³}[0]−R_{Î}_{³}[1]=h².

III. Properties of the Special Function

To explain how the Special Function can be used for clock recovery and for optimum phase sampling, some of its important properties can be considered. The Special Function exhibits periodicity over the sampling phase from 0 to T_{S}. This periodicity can easily be seen from EQ. 2, from which it follows that a shift of the sampling phase Ï□by T_{S} reduces the sample Î³ₙ to Î³_{n+1′} and results in the same Special Function.

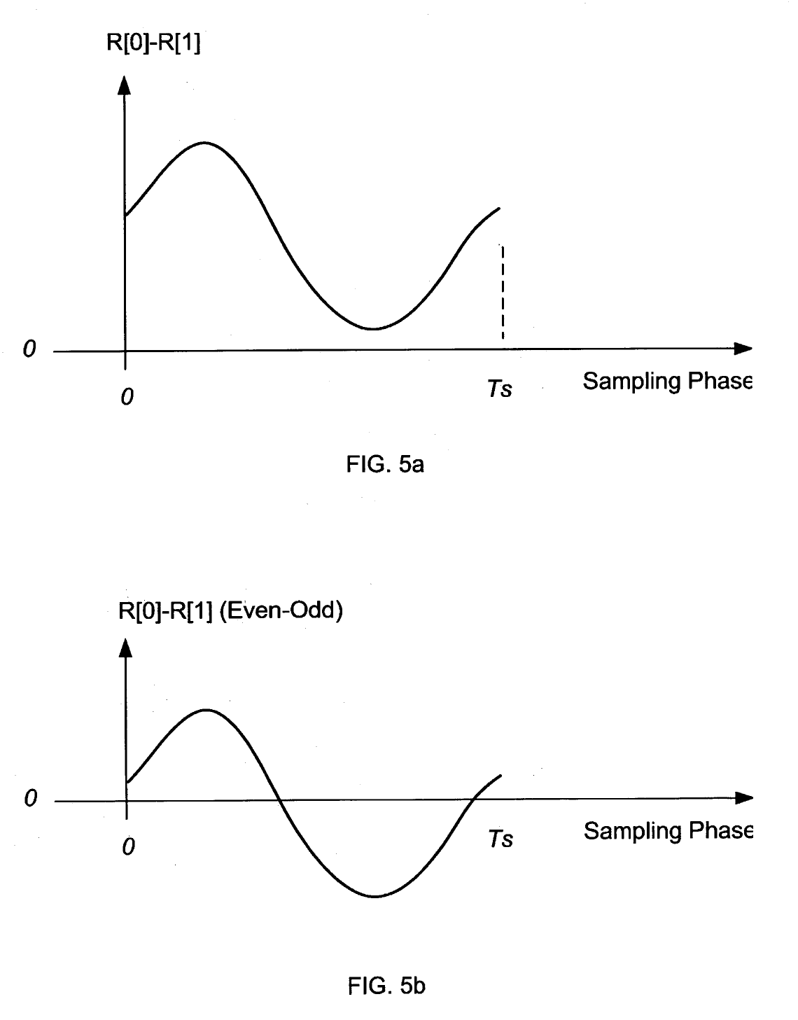

Since the impulse response h(t) is a continuous function of the sampling phase Ï□ the Special Function should have at least one maximum and one minimum over the period T_{S}. FIG. 5a is a typical graph of the Special Function with respect to the sampling phase Ï□ From EQ. 5, note that the Special Function is non-negative.

The Special Function can be computed separately for both even sample and odd-sample streams, e.g., from a 2× ADC output, to obtain an “Even S-Function” and an “Odd S-Function,” respectively. The Even S-Function and the Odd S-Function can both have the same value when the sampling phase is shifted by half of the sampling interval. This can be seen from the fact the even samples and odd samples have a sampling delay difference of T_{S}/2.

If the Even S-Function is subtracted from the Odd S-Function, or vice versa, the result has zero crossings. FIG. 5b is a typical graph of the Even S-Function subtracted from the Odd S-Function, again with respect to the sampling phase Ï□ Of particular importance, the result of this subtraction can be used as a phase difference signal in a phase lock loop for performing clock recovery. This is discussed further with respect to FIG. 7, presently.

If we compute the Special Function from a 1× ADC output, it is a sum of (hₙ−hₙ₊₁)². If one of the values h corresponds to the signal, the others correspond to either precursor or postcursor ISI. Therefore, it is desirable to maximize the Special Function to minimize the effect of ISI. When the Special Function is maximized, it not only helps in easier equalizer training but also in optimizing detection performance.

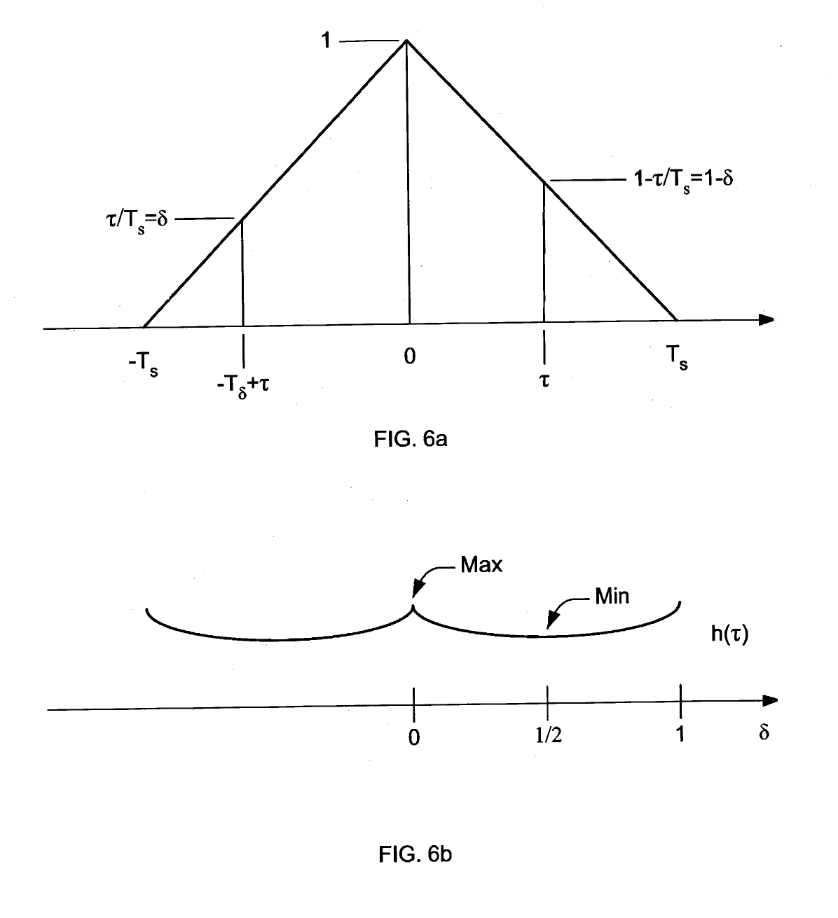

FIG. 6a-b are graphs presenting an example case of a channel where the Special Function gives a peak value of 1. In FIG. 6a the impulse response is defined by a symmetric triangle function of width 2T_{S} with its center peak equal to 1. From this it can be seen that the output is 1 if the sampling phase Ï□s 0. On the other hand, if the sampling phase is nonzero, the output is:

Rᵣ[0]−Rᵣ[1]=1−3λ+3λ² EQ. 6:

Here Î′=Ï□/T_{S′}, and has a maximum value 1 at sampling phase 0 and a minimum value of 0.25 at sampling phase of 0.5. From this, FIG. 6b follows and it can be seen that the sampling phase that gives the maximum value has no ISI, and the sampling phase that gives minimum value has strongest ISI (i.e., the same as the signal).

From these observations, it follows that the same Special Function used with a 2× ADC for clock recovery can be used with a 1× ADC for optimizing phase selection as well. Specifically, the sampling phase for the 1× ADC is the one that maximizes the Special Function. This is discussed further with respect to FIG. 8, presently.

IV. USE OF THE SPECIAL FUNCTION FOR CLOCK RECOVERY

FIG. 7 is a schematic block diagram depicting a clock recovery circuit 100 according to the present invention. The clock recovery circuit 100 includes an analog to digital converter (ADC 102), a de-multiplexer (demux 104), an even-function unit 106, an odd-function unit 108, a subtraction unit 110, a loop filter 112 (LF), and a clock oscillator 1.14 (VCO/ICO). The ADC 102 here is a 2× unit, i.e., one sampling at nominally twice the anticipated rate of the clock for which recovery is being performed. The demux 104 is straightforward. It splits the output of the ADC 102 into even and odd data streams. The even-function unit 106 receives the even data stream and the odd-function unit 108 receives the odd data stream. The function units 106, 108 can be, and typically will be, the same otherwise. The function units 106, 108 can be any units suitable for performing calculations according to the Special Function or equivalents. The subtraction unit 110 is also straightforward. The loop filter 112 and the oscillator 114 can be conventional, or specialized units adapted as particular applications or optimizations of the inventive clock recovery circuit 100 are desired. The oscillator 114 can be either a voltage or a current controlled unit, as a matter of design choice when implementing the clock recovery circuit 100.

Collectively, the ADC 102; the demux 104; the function units 106, 108; and the subtraction unit 110 form a phase detector 116. And from the prior discussion of principles, it can be appreciated that the subtracted even and odd outputs of the ADC 102 can be used as the phase detection output when performing clock recovery.

It should be noted that the number of bits of the ADC 102 used for clock recovery can be much fewer than then the number of the ADC 202 required for actual data recovery from the signal. For example, a 6-bit ADC unit can be sufficient for clock recovery purposes while an 8-bit or more unit is required for signal detection purpose. Since a 6-bit ADC can be implemented in a simple FLASH ADC architecture, the design complexity and the actual manufacturing costs for embodiments of the clock recovery circuit 100 can be quite low.

V. USE OF THE SPECIAL FUNCTION FOR OPTIMUM PHASE SAMPLING

Since the steady sampling phase at which the PLL is locked at the zero crossing of the even and odd difference of the Special Function and the optimum phase for equalizer training and signal detection is the one that maximizes the Special Function, a separate 1× ADC can be used to sample the received signal for equalization and detection.

FIG. 8 is a schematic block diagram depicting a phase sampling circuit 200 according to the present invention. The phase sampling circuit 200 includes an analog to digital converter (ADC 202), a delay line 204, a delay selection logic 206, and a function unit 208. The ADC 202 may be any unit suitable for the underlying task of signal sampling for data recovery, and thus may be conventional or otherwise.

The delay line 204 here is a 16-tap unit, with a total delay covering one symbol interval. A different number of taps might also be used, but the inventor's simulations indicate that a minimum would be four., Since an actual optimum phase can fall between two taps, a number higher than the minimum increases the probability of selecting a phase closer to the optimum. This can facilitate data detection, in a larger context in which the phase sampling circuit 200 is being employed. Additionally, it can also facilitate achieving more precise equalizer convergence and more rapid equalizer training.

The delay line 204 can be implemented as a chain of circuit buffers, as are well known to those skilled in the art. The delay selection logic 206 can also be implemented in many ways using well understood principles and circuits, as will be clear after the following discussion. The function unit 208 employs autocorrelation computation in the manner described above, and thus may particularly, use the Special Function. The function unit 208 may be the same as the function units 106, 108, but this is not a requirement.

FIG. 8 also shows the phase sampling circuit 200 integrated into the greater context of a receiver 250. In fact, the ADC 202 is an element of both the phase sampling circuit 200 and the receiver 250. The receiver 250 further includes a clock recovery system 252, an equalizer 254 and a detector 256. All of these may be conventional or otherwise. The clock recovery system 252 may be the clock recovery circuit 100 according to the present invention, such as the one in FIG. 7, but this is not a requirement and another type may be used instead.

In operation, the recovered clock (Cₖ) from the clock recovery system 252 is fed into the delay line 204 and the ADC 202 samples the received signal (R_{X}) from one of the 16 delay taps. The sampled output at the given delay tap selection is provided to the function unit 208, where it, in turn, undergoes autocorrelation and the result is fed back to the delay selection logic 206. The delay selection logic 206 then compares the respective tap results of the entire symbol interval to determine one tap of the delay line 204 that produces a maximum value. With this, the delay selection logic 206 sets the delay line 204 to use that tap, since the phase of the clock signal corresponding to it will be the optimum at which to sample the received signal. The receiver 250 may now proceed in straightforward manner, with training of the equalizer 254, if necessary, and actual data recovery with the detector 256.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### INDUSTRIAL APPLICABILITY

The present clock recovery circuit 100 is well suited for application in data recovery, particularly in digital communications. As has been described herein, working with a remotely received digital communications signal can pose the fundamental problems of clock recovery and selecting a suitable phase for data sampling. The invention especially addresses the problem of clock recovery, and may optionally also address the problem of selecting a data sampling phase. In particular, the invention can address both of the fundamental problems when a transmission has been band-limited and the received signal exhibits intersymbol interference (ISI).

As has also been described herein, the inventor's presently preferred embodiment of the invention uses an analog to digital converter (ADC) that samples the received signal at a rate twice the symbol rate. Alternating samples are then grouped into separate sample streams, one referred as the even samples and the other referred to as the odd samples. This embodiment then performs autocorrelations for the even and odd samples separately, and an arithmetic arrangement of these autocorrelations yields an output that is a strong function of the sampling phase and is a weak function of the transmitted data and channel ISI. Furthermore, the output has zero crossings at certain sampling phases. Since the output is monotonic as a function of the sampling phase at the zero crossings, it can be used as the phase detection output in the phase lock loop (PLL). With this novel approach, phase detection in the PLL can now be done independent of equalizer training and correct phase detection to begin with. The result is a very robust clock recovery scheme, based on simple autocorrelation methods or circuits.

The inventive clock recovery circuit 100 is also notable in its ability to fills needs where prior art techniques are severely limited or fail. For example, the invention does not require an already correctly detected clock recovery output to begin with, in marked contrast with techniques based on the present widely used Mueller-Muller method.

Nonetheless, once the teachings of this disclosure are grasped, the clock recovery circuit 100 is relatively easy to construct and employ. Embodiments may be constructed using relatively well known components, such as analog to digital converters (ADCs), de-multiplexing circuits, simpler digital calculating units, conventional oscillators, etc. Furthermore, procuring or constructing suitable instances of such components may be relatively straightforward and economical. For instance, the ADC used for clock recovery may be a 6-bit unit implemented in a simple flash architecture. If the invention is embodied to also handle the selection of a sampling phase, it may use an 8-bit ADC for that role, albeit the very same ADC used for ultimate data sampling and thus a component that adds little if any additional cost.

For the above, and other, reasons, it is expected that the clock recovery circuit 100 of the present invention will have widespread industrial applicability, and it is expected that the commercial utility of the present invention will be extensive and long lasting.

1. A method for generating a phase detection signal based on a received signal that has been generated based on a transmitter clock, the method comprising the steps of:
(a) collecting a stream of digital samples of the received signal at a sampling phase;
(b) calculating a stream of correlated data based on autocorrelation of said stream of digital samples; and
(c) deriving the phase detection signal based on said stream of correlated data.

2. The method of claim 1, wherein said sampling phase is derived directly from the received signal.

3. The method of claim 1, wherein said sampling phase is not chosen based on an intersymbol interference correction signal.

4. The method of claim 1, wherein:
said step (a) includes:
collecting said stream of digital samples at a sample rate of two per cycle of the transmitter clock; and
separating said stream of digital samples into a first sample stream and a second sample stream;
said step (b) includes:
calculating a first said stream of correlated data based on said first sample stream; and
calculating a second said stream of correlated data based on said second sample stream; and
said step (c) includes deriving the phase detection signal based on a difference between said first said stream of correlated data and said second said stream of correlated data.

5. The method of claim 1, wherein said autocorrelation is a strong function of said sampling phase.

6. The method of claim 5, wherein said autocorrelation is also a weak function of intersymbol interference in the received signal.

7. The method of claim 1, wherein said autocorrelation is based on the function R_{Î}_{³}[0]-R_{Î}_{³}[1].

8. A circuit for generating a phase detection signal based on a received signal that has been generated based on a transmitter clock, comprising:
a sampling sub-circuit suitable for collecting a stream of digital samples of the received signal at a sampling phase;
a calculating sub-circuit suitable for calculating a stream of correlated data based on autocorrelation of said stream of digital samples; and
said calculating sub-circuit further suitable for deriving the phase detection signal based on said stream of correlated data.

9. The circuit of claim 8, wherein said sampling sub-circuit includes an analog to digital converter.

10. The circuit of claim 9, wherein said analog to digital converter collects said stream of digital samples at a sample rate of two per cycle of the transmitter clock.

11. The circuit of claim 8, wherein:
said sampling sub-circuit includes a de-multiplexer suitable for separating said stream of digital samples into a first sample stream and a second sample-stream;
said calculating sub-circuit calculates a first stream of correlated data based on said first sample stream and calculates a second stream of correlated data based on said second sample stream; and
said calculating sub-circuit derives the phase detection signal based on a difference between said first said stream of correlated data and said second said stream of correlated data.

12. The circuit of claim 8, wherein said autocorrelation of said calculating sub-circuit is a strong function of said sampling phase.

13. The circuit of claim 12, wherein said autocorrelation of said calculating sub-circuit is also a weak function of intersymbol interference in the received signal.

14. The circuit of claim 12, wherein said autocorrelation of said calculating sub-circuit is also a weak function of random transmitted amplitudes.

15. The circuit of claim 8, wherein said autocorrelation of said calculating sub-circuit is based on the function R_{Î}_{³}[0]-R_{Î3}[1].

16. A method for recovering a transmitter clock from a received signal, the method comprising the steps of:
(a) deriving a phase detection signal based on autocorrelation of the received signal;
(b) generating a reference signal based on said phase detection signal; and
(c) locking with the received signal responsive to said:
reference signal, thereby synchronizing said reference signal with and thus recovering the transmitter clock.

17. The method of claim 16, wherein said step (a) includes:
(1) collecting a stream of digital samples of the received signal at a sampling phase;
(2) calculating a stream of correlated data from said stream of digital samples based on said autocorrelation; and
(3) deriving a phase detection signal based on said stream of correlated data.

18. The method of claim 17, wherein said sampling phase is derived directly from the received signal.

19. The method of claim 17, wherein said sampling phase is not chosen based on an intersymbol interference correction signal.

20. The method of claim 17, wherein:
said step (a)(1) includes:
collecting said stream of digital samples at a sample rate of two per cycle of the transmitter clock; and
separating said stream of digital samples into a first sample stream and a second sample stream;
said step (a)(2) includes:
calculating a first said stream of correlated data based on said first sample stream; and
calculating a second said stream of correlated data based on said second sample stream; and
said step (a)(3) includes deriving said phase detection signal based on a difference between said first said stream of correlated data and said second said stream of correlated data.

21. The method of claim 17, wherein said autocorrelation is a strong function of said sampling phase.

22. The method of claim 21, wherein said autocorrelation is also a weak function of intersymbol interference in the received signal.

23. The method of claim 21, wherein said autocorrelation is also a weak function of the random transmitted amplitudes.

24. The method of claim 16, wherein said autocorrelation is based on the function R_{Î}_{³}[0]-R_{Î}_{³}[1].

25. The method of claim 16, wherein said step (b) includes:
(1) filtering said phase detection signal into a driving signal; and
(2) driving a clock oscillator responsive to said driving signal to generate said reference signal.

26. The method of claim 25, wherein said clock oscillator is a member of the set consisting of voltage controlled oscillators and current controlled oscillators.

27. A circuit for recovering a transmitter clock from a received signal, comprising:
a phase detector suitable for providing a phase detection signal based on an autocorrelation of the received signal;
a loop filter suitable for converting said phase detection signal to a driving signal;
a clock oscillator suitable for generating a reference signal responsive to said driving signal; and
said phase detector further suitable for locking with the received signal responsive to said reference signal, thereby synchronizing said reference signal with and thus recovering the transmitter clock.

28. The circuit of claim 27, wherein said phase detector includes:
a sampling sub-circuit suitable for collecting a stream of digital samples of the received signal at a sampling phase;
a calculating sub-circuit suitable for calculating a stream of correlated data based on autocorrelation of said stream of digital samples; and
said calculating sub-circuit further suitable for deriving the phase detection signal based on said stream of correlated data.

29. The circuit of claim 28, wherein said sampling sub-circuit includes an analog to digital converter.

30. The circuit of claim 29, wherein said analog to digital converter collects said stream of digital samples at a sample rate of two per cycle of the transmitter clock.

31. The circuit of claim 28, wherein:
said sampling sub-circuit includes a de-multiplexer suitable for separating said stream of digital samples into a first sample stream and a second sample stream;
said calculating sub-circuit calculates a first stream of correlated data based on said first sample stream and calculates a second stream of correlated data based on said second sample stream; and
said calculating sub-circuit derives said phase detection signal based on a difference between said first said stream of correlated data and said second said stream of correlated data.

32. The circuit of claim 27, wherein said autocorrelation is a strong function of said sampling phase.

33. The circuit of claim 32, wherein said autocorrelation is also a weak function of intersymbol interference in the received signal.

34. The circuit of claim 32, wherein said autocorrelation is also a weak function of random transmitted amplitudes.

35. The circuit of claim 27, wherein said autocorrelation is based on the function R_{Î}_{³}[0]-R_{Î}_{³}[1].

36. The circuit of claim 27, wherein said clock oscillator is a member of the set consisting of voltage controlled oscillators and current controlled oscillators.

37. A method for sampling data in a received signal that has been generated based on a transmitter clock, the method comprising the steps of:
(a) recovering the transmitter clock based on autocorrelation of the received signal;
(b) selecting a sampling phase; and
(c) sampling the received signal for the data based on the transmitter clock and said sampling phase.

38. The method of claim 37, wherein said step (a) includes:
(1) providing a phase detection signal based on said autocorrelation of the received signal;
(2) generating a reference signal based on said phase detection signal; and
(3) locking with the received signal responsive to said reference signal, thereby synchronizing said reference signal with the transmitter clock and thus recovering the transmitter clock.

39. The method of claim 38, wherein:
said step (a)(1) includes collecting a first stream of digital samples of the received signal at a sample rate of two per cycle of the transmitter clock; and
said step (b)(1) includes collecting a second stream of digital samples of the received signal at a sample rate of one per cycle of the transmitter clock.

40. The method of claim 39, wherein said first stream of digital samples are collected with a fewer number of bits than said second stream of digital samples.

41. The method of claim 37, wherein said autocorrelation is based on the function R_{Î}_{³}[0]-R_{Î}_{³}[1].

42. The method of claim 37, wherein said autocorrelation is a clock recovery autocorrelation and said step (b) includes:
(1) obtaining a digital sample of the received signal for each of a plurality of phase delays of said transmitter clock;
(2) calculating data values based on a phase selection autocorrelation of said digital samples; and
(3) selecting one said phase delay of said transmitter clock as the sampling phase for the received signal based on said data values.

43. The method of claim 42, wherein said phase selection autocorrelation is based on the function R_{Î}_{³}[0]-R_{Î}_{³}[1].

44. A circuit for sampling data in a received signal that has been generated based on a transmitter clock, comprising:
a clock recovery sub-circuit suitable for recovering the transmitter clock based on an autocorrelation of the received signal;
a phase selection sub-circuit suitable for selecting a sampling phase; and
a sampling sub-circuit suitable for sampling the received signal for the data based on the transmitter clock and said sampling phase.

45. The circuit of claim 44, wherein said clock recovery sub-circuit includes:
a phase detector suitable for providing a phase detection signal based on said autocorrelation of the received signal;
a loop filter suitable for converting said phase detection signal to a driving signal;
a clock oscillator suitable for generating a reference signal responsive to said driving signal; and
said phase detector further suitable for locking with the received signal responsive to said reference signal, thereby synchronizing said reference signal with and thus recovering the transmitter clock.

46. The circuit of claim 44, wherein:
said clock recovery sub-circuit includes a first analog to digital converter; and
said phase selection sub-circuit includes a second analog to digital converter.

47. The circuit of claim 46, wherein:
said first analog to digital converter is suitable for sampling the received signal at a clock recovery sample rate of two per cycle of the transmitter clock; and
said second analog to digital converter is suitable for sampling the received signal at a phase selection rate of one per cycle of the transmitter clock.

48. The circuit of claim 46, wherein said first analog to digital converter samples a fewer number of bits than said second analog to digital converter.

49. The circuit of claim 44, wherein said autocorrelation is a clock recovery autocorrelation and said phase selection sub-circuit selects said sampling phase based on a phase sampling autocorrelation.

50. The circuit of claim 49, wherein at least one of said clock recovery autocorrelation and said phase selection autocorrelation are based on the function R_{Î}_{³}[0]-R_{Î}_{³}[1].
